(19) United States
(12) Patent Application Publication
(10) Pub. No.: US 2021/0040273 A1
(43) Pub. Date: Feb. 11, 2021

(54) MELTABLE LIGNIN COMPOSITIONS, METHOD FOR PRODUCING THEM AND THEIR USES

(71) Applicant: FPInnovations, Pointe-Claire (CA)

(72) Inventors: Makhlouf LALEG, Pointe-Claire (CA); Naceur JEMAA, Pointe-Claire (CA); Waleed WAFA AL DAJANI, Pierrefonds (CA); Yaolin ZHANG, Quebec (CA); Michael PALEOLOGOU, Beaconsfield (CA)

(21) Appl. No.: 16/968,193

(22) PCT Filed: Feb. 7, 2019
(86) PCT No.: PCT/CA2019/050161

§ 371 Date: Aug. 7, 2020

Related U.S. Application Data
(60) Provisional application No. 62/628,358, filed on Feb. 9, 2018.

(51) Int. Cl. C08J 3/12; C08L 97/02; C08L 97/00

(52) U.S. Cl. CPC C08J 3/12; C08J 2397/02; C08L 97/005; C08L 97/02

(57) ABSTRACT

Novel meltable lignin compositions having tailored compatibilities, moisture/water-resistant adhesion characteristics, and low to medium glass transition temperatures (30 to 120° C.) desirable for applications in the manufacturing of various products and the integration in the formulations of adhesives, coatings, plastics, composites and masterbatches, are obtained by blending at low temperatures (0-120° C.) dry lignins (0 to 10% moisture), in their hydrogen or protonated forms—hereby referred to as H-forms (pH=2.3-6.5 for a 10% aqueous suspension), with a reactive and/or interactive molecule or combination of molecules.

### CROSS-REFERENCE TO RELATED APPLICATIONS

The present application claims benefit of U.S. Provisional Application No. 62/628,358 filed Feb. 9, 2018, the content of which is hereby incorporated by reference in its entirety.

### TECHNICAL FIELD

It is provided a process of converting lignin powder into meltable lignin composition at low temperatures.

### BACKGROUND

Black liquor, a by-product of the kraft pulping process, has a high pH value of around 13. The degraded lignin molecules present in black liquor are acid precipitated to discrete aggregates or particles of up to 180 μm in diameter and separated from the residual liquor by filtration and purified and converted to the acid form through washing with dilute acid water (hereafter referred to as H-form kraft lignin). If H-form kraft lignin is dried and mechanically dispersed in water, turbid sols are formed. Sols of H-form kraft lignin before or after drying, are insoluble in water at neutral or acidic pH values, but can be dissolved in highly alkaline aqueous solutions (pH>10). H-form kraft lignin is soluble to a certain extent in many solvents such as aliphatic alcohols, methyl and ethyl acetate, acetone, chloroform, dioxane, pyridine, DMSO and THF. In particular, purified, H-form kraft lignins can be efficiently produced using the LignoForce™, LignoBoost™ and Westvaco processes. The H-form kraft lignin represents an abundant, inexpensive and biodegradable resource, but, so far, it has had only limited commercial applications. Fortunately, due to the presence of several functional groups, this lignin can be suitably modified to address the needs of several industrial applications. A more pure form of lignin, Lignol lignin, is also available in the H-form—this lignin is made by delignifying wood chips using the known Organosolv process which allows fractionating or separating woody biomass into its components of cellulose, hemicellulose and lignin.

Kraft lignin is a non-linear polymer characterized by a relatively high molecular weight (MW) and a compact structure as a result of significant intramolecular and intermolecular hydrogen bonding and pi-pi interactions. This leads to:
low solubility/reactivity and high viscosity in various reaction media;
low substitution rates in various applications; and
a glass transition temperature (softening point) which is quite high (about 160° C. for softwood and 130° C. for hardwood lignins, respectively)

A suitably modified lignin can be a valuable, lightweight product for use as a component of conventional thermoplastic polymers, rubbers and thermosetting resins, and in many polymer composite materials, emerging biodegradable plastics (Ecoflex and Ecovio from BASF, Polylactic acid (PLA) from NatureWorks, thermoplastic starch (TPS) from EverCorn™ and NatureWorks), wood polymer composites and thermoformed fiber products, adhesives for wood products and paperboard products, surface sizing and coating of paper and packaging materials, rigid polyurethane (PU) foams for thermal insulation, a precursor for carbon fibers, additive to asphalts, and in many other applications. However, there are some serious challenges to overcome when attempting to use dry H-form lignin powder in many of the above applications due to its poor compatibility, dispersion, dissolution and adhesion.

Generally, even though the dry H-form lignin is sometimes considered hydrophobic, its particles disperse well in water on mixing at neutral pH forming turbid sols without particle dissolution. These dry lignin particles or aggregates marginally soften at high temperatures of around 120 to 140° C. in the case of hardwood lignin and 150 to 180° C. in the case of softwood lignin. Therefore, their melting, such as when blending with hydrophobic thermoplastic polymers in an extruder, is not possible. For these reasons, in order to enable the use of lignin powder in thermal compounding as a filler, such as in an extruder or thermoforming of various products, plasticizers of polyether glycols or glycerol and/or coupling agents or compatibilizers such as MAPP (Maleated PolyPropylene), are required. Without suitable plasticizers and/or coupling agents, the lignin particles in the thermally compounded products remain poorly dispersed particulates in the polymer matrix resulting in composites of low strength properties. Furthermore, plasticizing lignin with polyethers, such as propylene or polypropylene glycols or polyols, such as glycerol, leads to a reduction in adhesion and tensile strengths and reduced water resistance of the end product.

For application in phenol formaldehyde resins, there are two types of resins: novolac and resol. Novolac resins are phenol-formaldehyde thermoplastic resins obtained under acid-catalyzed conditions that cannot react further without the addition of a cross-linking agent. They are supplied both in liquid or solid form with and without a curing agent. Hexamethylenetetramine is a hardener added to crosslink novolac resins via methylene and dimethylene amino bridges. Resol resins are made with the molar ratio of formaldehyde to phenol higher than one and the process is base catalyzed. The highly crosslinked resol resins have good thermal stability, chemical resistance and hardness and are therefore suitable for wood panel products, such as oriented strand board (OSB) and exterior plywood, for example. Presently, when H-form lignin is used with resol resins, the lignin must be dissolved in highly alkaline aqueous solutions. H-form lignin is not useful to utilize as is with solid form novolac resins. For novolac liquid as well as other thermoset resins (polyester and epoxy formulations) the lignin particles must dissolve and be compatible in order to add value.

For an efficient integration of kraft lignin in polyurethane foams the lignin particles need to be in a liquid form and compatible to react with the PU components during the foaming process or must become dissolved in one or both of its reactant constituents, isocyanates and polyols, which is not practical due to viscosity increase.

There exist very few known techniques for transforming dry kraft lignin particles to compatible or soluble materials that could easily and efficiently be blended with the above hydrophobic thermoplastics, thermosetting resins, and polyurethane and adhesive formulations. For example, U.S. Pat. No. 6,054,562 describes the production of a composition comprising lignin plasticized with a polyether compound or a polyol (such as polypropylene glycol) at a mixing temperature of around 130° C. The final dry compound is said to be brittle, has improved melt and flow characteristics and has a form similar to a dry phenolic resin. It is further described that this new modified lignin can be cured with hexamine like a phenolic resin. However, when tested, and based on knowledge of plasticizing H-form lignin with a polypropylene glycol, the final product has high glass transition temperature Tg and is water sensitive at neutral pH and has very limited adherence properties to hydrophobic materials.

Patent application publication no. U.S. 20150259369 describes the production of hydroxyalkoxylated lignins by reacting in extrusion processes at high temperatures, over 150° C., kraft lignin and a cyclic alkylene carbonate, such as propylene carbonate, in the presence of catalysts such as basic/alkaline compounds (e.g. potassium/sodium carbonate or lime) and aromatic, aliphatic or heterocyclic amines (such as tributylamine, imidazole and imidazole derivatives as non-nucleophilic bases, 1-methylimidazole as a volatile base catalyst). The produced hydroxyalkoxylated lignins were ground to powder then blended in an extruder with polybutylene adipate terephthalate (PBAT) for the manufacture of films.

Bouajila et al. (2006, J. Appl. Polym. Sci., Vol. 102, 1445-1451) investigated lignin plasticization with several materials. Firstly, they prepared plasticizers solution (ethanol or water), and mixed it with Westvaco pine kraft lignin as received (the pH of 2% aqueous solution was 6.5), removed the solvent, dried, ground the specimens after drying, equilibrated the moisture content if needed, and evaluated the glass transition temperature by DSC (differential scanning calorimetry). They found that water content in lignin significantly reduced the glass transition temperature (Tg). Apart from water, the solutions used contained ethylene glycol, diethylene glycol, triethylene glycol, tetra(ethylene glycol), hexa(ethylene glycol), poly(ethylene glycol), poly(ethylene glycol) dimethyl ether, ethylene carbonate, propylene carbonate, 6-caprolactone monomer, vanillin, acetovanillone, acetosyringone, homovanillic acid, or lactic acid.

The above techniques, however, are very complicated, demonstrate low performance, present serious limitations, and add high cost to raw lignin. It is thus highly desired to be provided with an effective way to allow the use of H-form lignin in industrial applications.

### SUMMARY

In accordance with the present description, it is provided a process of preparing a meltable lignin composition comprising blending lignin powder with at least one reactive molecule that interferes with lignin's intra- and intermolecular hydrogen bonding and pi-pi interactions producing granular particles upon cooling; and melting the granular particles into meltable lignin with an adjustable glass transition temperature, reactivity, and processability.

In an embodiment, the meltable lignin composition could be held together by physical forces (e.g. intra- and intermolecular hydrogen bonding and pi-pi interactions) or it could be a meltable lignin composition prepared by either heating the meltable lignin composition to induce a reaction between its two main components, and/or using a molecule that reacts with the lignin without heat being needed.

In an embodiment, the meltable lignin is liquid, viscous or a dense solid material.

In another embodiment, the dense solid material is a pellet, granules or a powder form.

In a further embodiment, the lignin powder is H-form lignin.

In another embodiment, the glass transition temperature is between 30° C. and 120° C.

In another embodiment, the lignin powder comprises 0 to 10% moisture.

In a further embodiment, the lignin powder is at pH=2.3 to 6.5 as measured in a 10% aqueous suspension.

In another embodiment, the lignin in the H-form is from hardwood, softwood, or another biomass resource.

In a further embodiment, the lignin powder is blended with the at least one reactive molecule at a temperature between 0° C. and 120° C.

In a further embodiment, the lignin powder and the reactive molecule are blended at a temperature between 40° C. and 80° C.

In an embodiment, the lignin powder and the reactive molecule are blended at a temperature between 20° C. and 60° C.

In a further embodiment, the process described herein further comprising the initial step of extracting the lignin powder from kraft black liquor by acidification followed by purification and conversion through acid and water washing.

In another embodiment, the lignin powder is a product of the LignoForce™′ LignoBoost™ or Westvaco processes (e.g. Indulin AT).

In another embodiment, the H-form lignin powder is originally produced from a soda pulping process, a dissolving pulp process (i.e., from the chip prehydrolysis step prior to pulping), an organosolv process, an enzymatic process or a steam explosion process.

In a further embodiment, the lignin powder is first passed through a screw feeder before being blended with the at least one reactive molecule.

In an embodiment, the lignin powder is blended with the at least one reactive molecule in a jacketed heater with twin arm mixing.

In a further embodiment, the mixed lignin powder and the at least one reactive molecule are further passed through a second screw feeder before being mixed in a second jacketed heater with twin arm mixing producing meltable lignin composition in viscous form.

In another embodiment, the lignin powder is blended with the at least one reactive molecule in a kneader, an ultrahigh-speed thermokinetic mixer Gelimat from DUSATEC Gelimat™ Technology or an extruder of a single screw or twin screws.

In a further embodiment, the at least one reactive molecule comprises double or triple bonds; conjugated double or triple bonds; acyl groups attached to oxygen, nitrogen, halogen, or sulphur atoms; halogenated α-carbon of carboxylic acids; glycidyl groups; cyclic structures with hydroxyl or carbonyl groups, or repeat units with oxygen atoms and wherein the reactive molecule is in the liquid or molten solid form.

In an embodiment, the at least one reactive molecule is a carbonate ester; an amide and cyclic urea derivative, an aldehyde, a ketone, a conjugated system with carbon-carbon and carbon-nitrogen bonds, a carboxylic acid, a dicarboxylic acid, an acrylic acid, an acrylate, a carboxylic acid anhydride, an acyl halide, a carboxylic acid ester, a furan, an isocyanate, a polyethylene glycol-based polymer, a substituted silane, a sulfone or a sulfoxide.

In a further embodiment, the at least one reactive molecule is an ethylene carbonate, a propylene carbonate, a glycerine carbonate, a N,N-dimethylformamide, a N,N-dimethylacetamide, urea, a 2-imidazolidone, a 1,3-dimethyl-2-imidazolidinone, a cinnamaldehyde, a vanillin, an acetovanillone, an acrylonitrile, a styrene, an acetic acid, an acrylic acid, a malic acid, an oxalic acid, a glycidyl methacrylate, a 2-hydroxyethyl methacrylate, a methyl acrylate, a methyl methacrylate, a chloroacetic acid, a trichloroacetic acid, a cyclohexanone, a 1,3-benzenediol, a 1,4-cyclohexanedimethanol, an acetic anhydride, a maleic anhydride, a phthalic anhydride, a succinic anhydride, an acetyl bromide, a ε-caprolactone, a ε-caprolactam, a L-lactide, a vinyl acetate, a polyvinylacetate, poly(butylene adipate-co-terephthalate) (PBAT), triacetin, a furfuryl alcohol, a furfural, a poly(methylene diphenyl diisocyanate), polyethylene glycol, Triton™ X-100, Tween® 20, Tween® 80, a poly(ethylene glycol) diglycidyl ether, a 3-(trimethoxysilyl)propyl methacrylate, a (3-aminopropyl)triethoxysilane, a dimethyl sulfone, or a dimethyl sulfoxide.

It is also provided a meltable lignin composition produced by the process described herein.

In an embodiment, the meltable lignin composition comprises between 1 and 90%, preferably between 20 and 90 wt % of dry H-form kraft lignin.

In another embodiment, the meltable lignin composition comprises between 40 and 70 wt % of dry H-form kraft lignin.

In a further embodiment, the composition described herein further comprises hydrophobic liquids, resins, polymers, melting chemical liquids, polar solvents or non-polar solvents.

In a further embodiment, the composition described herein further comprises polyurethane compositions or thermosetting resins.

In an embodiment, the meltable lignin composition is further bound to an underivatized or derivatized chemical pulp, an underivatized or derivatized mechanical pulp, an underivatized or derivatized organosolv pulp, an underivatized or derivatized non-wood pulp, a plastic, glass, a metal, aluminum, a mineral filler, asphalt, a starch powder, a hemicellulose extract, a wood powder, a wood particle, a wood fiber, dry micro-cellulose material, a nano-cellulose material, or a seed.

In another embodiment, the meltable lignin composition is further compounded with a thermoplastic polymer.

In an additional embodiment, the thermoplastic polymer is polyethylene (PE), polypropylene (PP), polyvinyl chloride (PVC), polystyrenes (PS), polypropylene carbonates (PPC), thermoplastic polyurethanes (TPU), thermoplastic elastomers (TPE), acrylonitrile-containing copolymer, asphalt, wax, thermoplastic starch (TPS), polyvinyl alcohol (PVOH), polyethylene oxide (PEO), rubbers, latexes, polyglycolide, polyglycolic acid (PGA), polylactic acid (PLA), polycaprolactone (PCL), polyhydroxyalkanoate (PHA), polyhydroxybutyrate (PHB), polyethylene adipate (PEA), polybutylene succinate (PBS), poly(3-hydroxybutyrate-co-3-hydroxyvalerate) (PHBV), polyethylene terephthalate (PET), polybutylene terephthalate (PBT), cyclic butylene terephthalate (CBT), polybutyrate adipate terephthalate (PBAT), polytrimethylene terephthalate (PTT), or polyethylene naphthalate (PEN).

In a further embodiment, the meltable lignin composition is further used as a coating on wood, paper, concrete, asphalt, plastic, glass, metal, composite materials and seeds.

In a further embodiment, the meltable lignin comprises a glass transition temperature of 30° C. to 120° C.

It is also provided an application composition comprising a meltable lignin composition produced by the process as described herein, the application composition is an adhesive, a thermosetting resin, a thermosetting fiber-reinforced composite, a bulk molding compound (BMC), a sheet molding compound (SMC), a black mulch paper, a black plastic mulch, an asphalt composition, a paperboard material, a corrugated container, a thermoformed-shaped product, a particle board, low density, medium density and high density (LDF, MDF and HDF) board products, a wood-plastic composite, a plastic composition, a thermoplastic starch, an insulating material, a seed coating composition, a wood product, or a concrete composition.

### BRIEF DESCRIPTION OF THE DRAWINGS

Reference will now be made to the accompanying drawings.

FIG. 1 illustrates a process for producing meltable lignin in viscous form in accordance to an embodiment.

FIG. 2 illustrates a process for producing meltable lignin in pellet form in accordance to another embodiment.

FIG. 3 illustrates meltable lignin compositions in liquid (left) and solid particle (right) forms as encompassed in one embodiment.

FIG. 4 illustrates microscopy images of meltable lignin composition wherein (left) in granular form and (right) a magnification showing complete transformation of dry particulates of initial H-form kraft lignin.

FIG. 5 illustrates the mixing of H-form lignin with propylene carbonate in (a) lignin powder; in (b) mixture of lignin (90 wt %) and propylene carbonate (10 wt %); in (c) meltable lignin composition after mixing in Gelimat compounder.

FIG. 6 illustrates a bar graph showing the adhesive bond strength after substituting 50% of PF content by meltable lignin composition (dry testing).

FIG. 7 illustrates a bar graph showing the adhesive bond strength after substituting 50% PF content by meltable lignin composition (wet testing).

FIG. 8 illustrates a bar graph showing the adhesive bond strength of two meltable lignin blends (dry testing).

### DETAILED DESCRIPTION

In accordance with the present description, there is provided the production of novel meltable or fusible lignin compositions, in solid, viscous and liquid forms by blending at low temperatures dry lignin powder with reactive molecules. These meltable lignin compositions are suitable as intermediary agents that can be used as is, or combined with other existing formulations such as thermoplastics, rubbers, thermosetting resins, fiber-reinforced composites, adhesives of wood and paperboard products, wood stain/paint, surface sizing and coating of wood, paper, and paperboard products, and to make already premixed compositions or masterbatches.

It is provided that a certain number of small MW compounds are able to penetrate the lignin molecular network and overcome the intramolecular and intermolecular hydrogen bonding and/or pi-pi interactions by either forming stronger interactions of these types with the lignin or by reacting with certain lignin functional groups (thereby making these functional groups unable to be involved in intramolecular and intermolecular hydrogen bonding and/or pi-pi interactions and/or providing new properties to the modified lignin). These interactions are often so strong that the whole lignin composition (lignin plus added compound(s)) behaves as one chemical entity (e.g. displays only one glass transition temperature instead of two). Depending on the chemical nature, reactivity and the strength of the interactions of any given small MW compound with lignin, one can prepare a range of meltable lignin compositions with the desirable chemical and softening characteristics to meet the needs of different applications (i.e. tune the lignin composition to the desired application).

The present description proposes a new cost-effective approach that uses safe chemicals under simple conditions to convert lignin powder into meltable lignin compositions. It is described herein that H-form lignin of hardwood or softwood or any other or other biomass resource, which do not have any distinct melting point or flow characteristics on heating, when blended with identified reactive molecules at temperatures between 0 and 120° C., it was possible to rapidly melt its granular particles to an intensely black liquid, viscous or dense solid materials, depending on the type and amount of reactive molecules used. Importantly, lignin in the sodium form did not yield a meltable lignin product when mixed with the chemicals described herein under the conditions provided herein. In the case of H-lignin, the produced solid compounds behaved like a thermoplastic polymer with melting and drawing characteristics as well as rheological (e.g viscosity) and thermal properties (e.g. glass transition temperature, Tg) similar to thermoplastic polymers. On heating it softens and melts, then when cooled down it rapidly solidifies. This thermoplastic characteristic can be repeated several times without impairing the inherent properties of the initial lignin or the formed compound to any significant extent. Both the DSC (Differential Scanning calorimetry) and the DMA (Dynamic Mechanical Analysis) results of the solids admixtures confirmed well these thermal characteristics. For example, the Tg of raw softwood kraft lignin, which was around 180° C., dropped to 60° C. after blending it with an amount of some of the identified chemicals encompassed herein.

Accordingly, the resulting meltable lignin has an adjustable glass transition temperature, reactivity, and processability. The proportion and type of molecule(s) used to make the meltable lignin composition will determine its glass transition temperature, reactivity, and state (liquid, viscous, or dense solid). These factors will make the meltable lignin composition compatible with the processing needed in the final application, e.g. in adhesives, a blender is needed.

In a preferred embodiment, the dry H-form kraft lignin portion of the meltable lignin compositions is between 20 and 90 wt %, in particular, between 40 and 70 wt % admixtures. Variation of the lignin portion and the type of the reactive molecules in the admixtures allow the production of a variety of compositions in solid or liquid forms, at temperatures between 0 and 120° C., more preferably between 40 and 80° C., suitable for additional transformations or direct applications. The meltable lignin compositions can be produced in pellet, granule and powder forms or in viscous or liquid forms.

Raw dry lignin powders encompassed herein are for example LignoForce™′ LignoBoost™ or Indulin AT, products all extracted from kraft black liquor by acidification followed by purification and conversion to the H-form through acid and water washing. LignoForce™ are particularly found to be much easier to process with the identified chemicals and have more adhesive properties. Lignin powders from other sources such as the soda pulping process, dissolving pulp process (i.e., from the chip prehydrolysis step prior to pulping), organosolv processes, enzymatic processes or steam explosion processes when converted to the H-form are also encompassed herein.

The meltable solid lignin compositions as described herein are compatible and mix well with many hydrophobic liquids, resins or polymers and dilute well in excess of melting chemical liquids as well as in common polar and non-polar solvents or reactive molecules. They bind or adhere to many materials such as underivatized or derivatized chemical pulp, underivatized or derivatized mechanical pulp, underivatized or derivatized organosolv pulp, underivatized or derivatized non-wood pulp, plastic, glass, metal, aluminum, mineral fillers, asphalt, starch powder, hemicellulose extracts, wood powder, wood particles or wood fibers, and dry micro- and nano-cellulose materials. In particular, the meltable lignin compositions were found suitable to use in adhesive formulations of wood products, paperboard materials, and paper core board and corrugated paperboard products. They are useful for surface sizing and coating paper products such as replacement of synthetic wax for paperboard packaging and for paper mulch. When the lignin is melted with some selected chemicals encompassed herein, its liquid admixtures can be blended, dispersed or emulsified with water-based polymers, latexes, resins or other material compositions for different applications. In particular, with some selected reactive molecules used, the meltable lignin compositions were found suitable to blend with polyurethane compositions (isocyanates/polyols) and thermosetting resins for making rigid foams.

The meltable lignin compositions can also be used as encompassed herein for making premixed compositions or masterbatches of mineral filler, pigment, wood flour, starch powder and bulking agents, powder of thermoplastic polymers or powder thermosetting resins tailored for a range of applications. For instance, in wood adhesives, the meltable liquid lignin compositions can be used as is to substitute a large portion of phenol formaldehyde resol, phenol formaldehyde novolac, urea formaldehyde or melamine urea formaldehyde while maintaining or improving the dry and wet bond strength over the initial resins. These novel meltable lignin compositions allow a substantial reduction in the use of toxic petroleum based-chemicals used in adhesives such as phenol and formaldehyde.

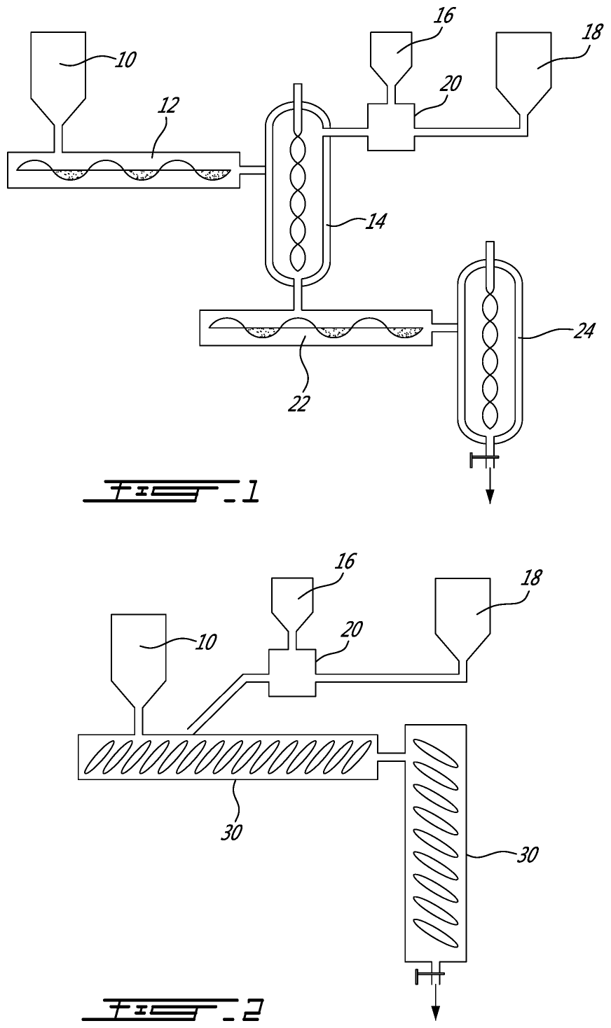

Production of the meltable lignin compositions as described herein comprises processing steps of blending and extrusion techniques, such as those illustrated in FIGS. 1 and 2.

As illustrated in FIG. 1, lignin powder 10 (0-10% moisture, and more preferably in the range 0-5%), H-form (pH=2.3-6.5 for a 10% aqueous suspension, and more preferably in the range 2.3-5.0) is passed through a screw feeder 12 before being mixed with one or more reactive molecules (solid 16 and/or liquid 18 which can be premixed in a mixing unit 20) in a jacketed heater with twin-arm mixing 14 for example. The mixed lignin composition (H-form lignin and reactive molecules) is then passed through a second screw feeder 22 before being mixed again in a jacketed heater with twin-arm mixing 24, producing meltable lignin in viscous form. Also encompassed in the mixing of the lignin powder H-form and reactive molecules in a kneader, an ultrahigh-speed thermokinetic mixer Gelimat from DUSATEC Gelimat™ Technology or an extruder 30 as seen in FIG. 2 turning the solid form compositions into pellets or granules, or filaments, or any other mixing vessel that can blend viscous materials at room temperature and up to 120° C., preferably in the range of 40 to 80° C., and more preferably in the range 20 to 60° C. into meltable lignin compositions in liquid, viscous or solid forms are encompassed. With some identified molecules, their reactions with lignin produce by-products that can be removed by known vacuum degassing techniques.

The meltable lignin compositions described herein can be processed at the site of product manufacturing or application or supplied in pellets, granules or semi-liquid viscous or liquid materials.

As encompassed herein, the identified reactive molecules used to transform the dry lignin powder or granules to the meltable lignin compositions encompassed herein interfere with lignin's intra- and intermolecular hydrogen bonding and pi-pi interactions. The reactive molecules encompassed herein and comprised in the meltable lignin compositions described herein react chemically and bind with lignin as well as enhancing the lignin interaction, reactivity, and compatibility toward the components of encompassed application compositions namely adhesives, thermoplastics, thermosets, polyurethane foams, composites, and others as described herein. The preferred identified molecules are selected based on their ability to melt the lignin by means of penetration, reaction, or interaction to provide adhesive characteristics to lignin, high flash points, high boiling points and low evaporation rates, low emission levels of VOCs, low toxicity, and low odor. It is envisaged that the presence of the reactive molecules in the meltable lignin compositions, can later chemically react and bind with lignin as well as with enhancing lignin interaction, reactivity, and compatibility toward the components of the application compositions, namely those of adhesives, thermoplastics, thermosets, polyurethane foams, and composites.

For example, molecules belonging to certain families with the same functional group can react/interact with dry lignin powder causing it to melt to a liquid that behaves as a strong adhesive or to a solid that behaves as a thermoplastic or thermosetting polymer. They can be blended alone or in combination with each other with dry lignin in its H-form to provide meltable lignin compositions upon mixing at temperatures between 0 and 100-120° C., depending on the reactive molecules used.

Molecules that form meltable lignin compositions can have one or more of the following structural characteristics:
double or triple bonds (C═C, C═O, S═O, C═S, C═N, C≡N);
conjugated double or triple bonds (C═C—C═C, C═C—C═O, C═C—C≡N);
acyl groups attached to oxygen, nitrogen, halogen, or sulphur atoms;
halogenated α-carbon of carboxylic acids;
glycidyl groups

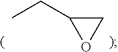

cyclic structures with hydroxyl or carbonyl groups; and/or
repeat units with oxygen atoms (—CH₂—CH₂—O-)n.

Below is a list of, but not limited to, some examples of molecules that, alone or in combination, were demonstrated to have the ability to react/interact with H-form lignin to form meltable lignin compositions:

### Carbonate Esters

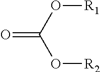

| | | |
|---|---|---|
| Ethylene carbonate | Liquid | 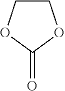 |
| Propylene carbonate | Liquid | 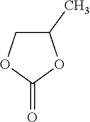 |
| Glycerine carbonate | Liquid | 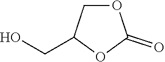 |

### Amides and Cyclic Urea Derivatives

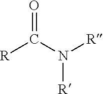

| | | |
|---|---|---|
| N,N-Dimethylformamide | Liquid | 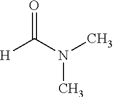 |
| N,N-Dimethylacetamide | Liquid | 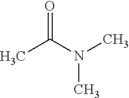 |
| Urea | Solid; mp 132-135° C. | 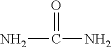 |
| 2-Imidazolidone | Solid; mp 129-132° C. | 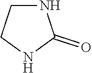 |
| 1,3-Dimethyl-2-imidazolidinone | Liquid | 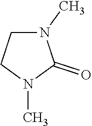 |

### (Conjugated) Aldehydes and Ketones (Enones)

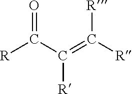

| | | |
|---|---|---|
| Cinnamaldehyde | Liquid | 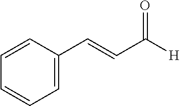 |
| Vanillin | Solid; mp 81-83° C. | 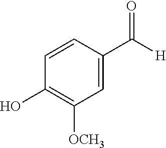 [SMILES: COc1cc(C=O)ccc1O] |
| Acetovanillone | Solid; mp 112- 115° C. | 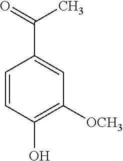 |

Conjugated systems with carbon-carbon and carbon-nitrogen bonds

| | | |
|---|---|---|
| Acrylonitrile | Liquid | 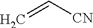 |
| Styrene | Liquid | 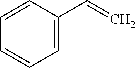 |

### Carboxylic Acids, Dicarboxylic Acids, Acrylic Acid, and Acrylates

| | | |
|---|---|---|
| Acetic acid | Liquid | 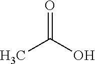 |
| Acrylic acid | Liquid | 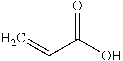 |
| Malic acid | Solid; mp 131- 133° C. | 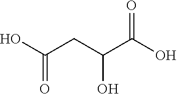 |
| Oxalic acid | Solid; mp 189.5° C. | 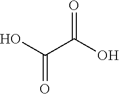 |
| Glycidyl methacrylate | Liquid | 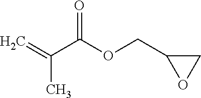 |
| 2-Hydroxyethyl methacrylate | Liquid | 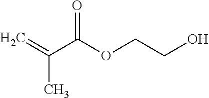 |
| Methyl acrylate | Liquid | 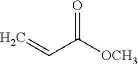 |
| Methyl methacrylate | Liquid | 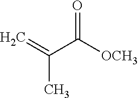 |

### Halogenated Acetic Acid

| | | |
|---|---|---|
| Chloroacetic acid | Solid; mp 60-63° C. | 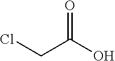 |
| Trichloroacetic acid | Solid; mp 54-58° C. | 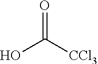 |

Cyclic Compounds with Hydroxyl and Carbonyl Groups

| | | |
|---|---|---|
| Cyclohexanone | Liquid | 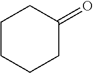 |
| 1,3-Benzenediol | Solid; mp 109-112° C. | 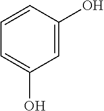 |
| 1,4-Cyclohexanedimethanol | Solid; mp 41-61° C. | 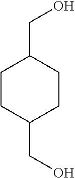 |

### Carboxylic Acid Anhydrides

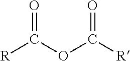

| | | |
|---|---|---|
| Acetic anhydride | Liquid | 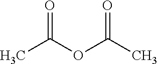 |
| Maleic anhydride | Solid; mp 52-54° C. | 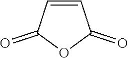 |
| Phthalic anhydride | Solid; mp 131-134° C. | 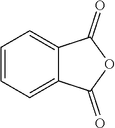 [SMILES: O=C1OC(=O)c2ccccc21] |
| Succinic anhydride | Solid; mp 118-120° C. | 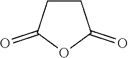 |

### Acyl Halides

| | | |
|---|---|---|
| Acetyl bromide | Liquid | 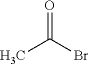 |

### Carboxylic Acid Esters

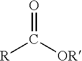

| | | |
|---|---|---|
| ε-Caprolactone | Liquid | 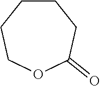 |
| ε-Caprolactam | Solid; mp 68-71° C. | 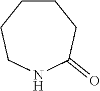 |
| L-Lactide | Solid; mp 95-98° C. | 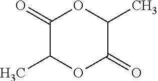 |
| Vinyl acetate and polyvinylacetate | | 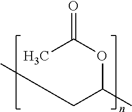 |
| Poly(butylene adipate- co-terephthalate) (PBAT) | Solid; mp ~120° C. | 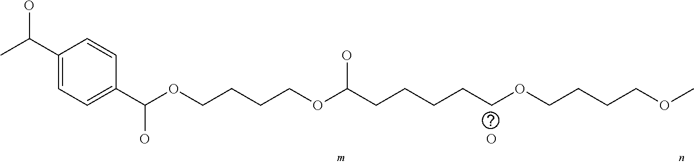 |
| Triacetin | Liquid | 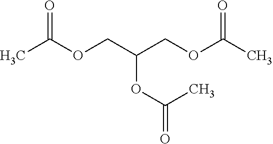 |

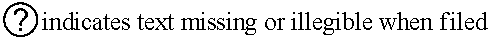

### Furans

| | | |
|---|---|---|
| Furfuryl alcohol | Liquid | 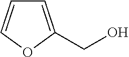 |
| Furfural | Liquid | 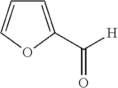 |

### Isocyanates

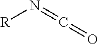

| | | |
|---|---|---|
| Poly(Methylene diphenyl diisocyanate) | Liquid | 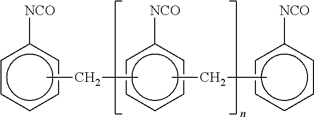 |

### Polyethylene Glycol-Based Polymers

| | | |
|---|---|---|
| Polyethylene glycol 400 Polyethylene glycol 1000 Polyethylene glycol 3500 | Liquid Waxy Solid | 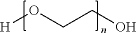 |
| Polyethylene glycol 8000 | Solid | |
| Triton ™ X-100 [4-(1,1,3,3- Tetramethylbutyl)phenyl- polyethylene glycol] | Liquid | 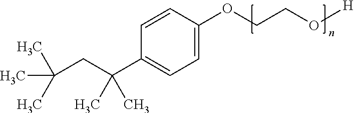 |
| Tween ® 20 [Polyethylene glycol sorbitan monolaurate] C₅₈H₁₁₄O₂₆ MW = 1228 g/mol | Liquid | 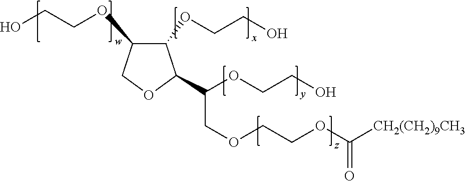 |
| Tween ® 80 [Polyethylene glycol sorbitan monolaurate] C₅₈H₁₁₄O₂₆ MW = 1228 g/mol | Liquid | 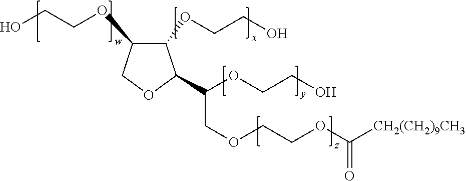 |
| Poly(ethylene glycol) diglycidyl ether, average Mₙ 500 | Liquid | 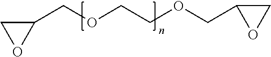 |

### Substituted Silanes

| | | |
|---|---|---|
| 3-(Trimethoxysilyl)propyl methacrylate | Liquid | 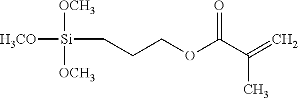 [SMILES: C=C(C)C(=O)OCCC[Si](OC)(OC)OC] |
| (3-Aminopropyl)triethoxysilane | Liquid | 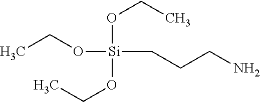 |

### Sulfones and Sulfoxides

| | | |
|---|---|---|
| Dimethyl sulfone | Solid; mp 107-109° C. | 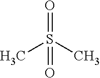 |
| Dimethyl sulfoxide | Liquid | 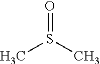 |

The choice of a simple chemical molecule or a monomer or their combinations to transform a dry H-form lignin to a meltable lignin composition is based on the intended application of the composition. Accordingly, the alkylene carbonate chemical family, for example, has been found to produce meltable lignin compositions useful for application in adhesives of phenol formaldehyde resins, urea formaldehyde resins, melamine and melamine urea formaldehyde resins. On the other hand, the choice of the acrylate chemical family is more preferred to produce meltable lignin compositions efficient for application in thermoplastic polymers.

The reaction or interaction of reactive molecules with the active hydrogen-containing groups in lignin is expected to be the main mechanism of imparting the useful properties to the meltable lignin compositions, namely: improved adhesive properties in wood product applications, improved reactivity with polyisocyanate in polyurethane foam production or improved compatibility with many polymers, resins and ingredients of composites.

Examples of possible uses of the meltable lignin compositions encompassed herein are, depending on the reactive molecules used, masterbatches (premixed with various ingredients and/or powders of thermoplastic polymers), or later compounded with thermoplastic polymers such as Polyethylene (PE), Polypropylene (PP), Polyvinyl chloride (PVC), Polystyrenes (PS), Polypropylene carbonates (PPC), Thermoplastic polyurethanes (TPU), Thermoplastic elastomers (TPE), Acrylonitrile-containing copolymer (rubber), Asphalt, Wax, Thermoplastic starch (TPS), Polyvinyl alcohol (PVOH), Polyethylene oxide (PEO), rubbers, latexes and many thermoplastic polyesters such as Polyglycolide or Polyglycolic acid (PGA), Polylactic acid (PLA), Polycaprolactone (PCL), Polyhydroxyalkanoate (PHA), Polyhydroxybutyrate (PHB), Polyethylene adipate (PEA), Polybutylene succinate (PBS), Poly(3-hydroxybutyrate-co-3-hydroxyvalerate) (PHBV), Polyethylene terephthalate (PET), Polybutylene terephthalate (PBT), Cyclic butylene terephthalate (CBT), Polybutyrate adipate terephthalate (PBAT), Polytrimethylene terephthalate (PTT), and Polyethylene naphthalate (PEN), for example, but not limited to. The meltable lignin compositions can be used for substituting a large portion of synthetic polymers with minimal change in tensile strength properties or used as plasticizing agents to tailor some specific end use properties such as increasing elongation to break and impact resistance at the expense of some tensile and stiffness reduction.

Meltable lignin compositions of viscous or fluid forms can be made to blend with hydrophobic thermosetting resins such as epoxy and polyester for various applications, namely adhesives and thermosetting fiber-reinforced composites. These viscous and liquid compositions can be made to disperse with water-based thermosetting resins, namely the phenolic, urea and melamine formaldehyde resins, and the water-based, acrylic polymers or resins Aquaset™ and Acrodur®, commonly used for adhesives and fiber bonding applications.

The meltable lignin compositions can be blended with other compositions that contain polymers, mineral fillers and/or wood fibers, wood flour, starch powder, to create fully or partially compostable products used for making black mulch paper and black plastic mulch or used as a replacement of petroleum-based asphalt in waterproofing membranes or asphalt for road applications. Of particular interest is the use of meltable lignin compositions as encompassed herein in paperboard materials and corrugated containers, as a replacement of petroleum-based waxes and the adhesive formulations of starch, for the purpose of making containers stronger and more water resistant. Additionally, the meltable lignin compositions in pellet or granule forms when blended with wood flour and co-additives can be converted in injection molding extrusion machines and vacuum forming processes to create various thermoformed-shaped products. Shaped products can be produced using the meltable lignin compositions made by the method described herein using known processing methods such as kneading, extruding, melt spinning, compression molding, injection molding, 3D printing, for example and not limited to, at temperatures in the range of 20° C. to 240° C. or more, provided that at higher temperatures precautions are used to avoid degradation of lignin and chemicals, and can have any form such as for example 3D products, films, membranes and fibers.

The meltable lignin compositions of liquid or viscous forms can also be used as a surface sizing and coating agent for the production of specialty water-proof papers, as a coating agent or binding agent for the production of particle board, as a binding agent for starch for the production of water-proof thermoplastic starch and starch derivatives, as an insulating material and can be used for seed coating. The lignin portion is expected to provide such materials a wood-like appearance and character which is desired in many applications. The black color can be tailored to different colors by introduction of bright mineral fillers such as titanium dioxide, calcium carbonate, clay, silica and talc.

Wood products such as plywood, medium density fiberboard (MDF), particleboard (PB), oriented strandboard (OSB), and laminated veneer lumber (LVL) employ significant amount of adhesives. The most commonly used adhesives are phenol-formaldehyde (PF), urea-formaldehyde (UF), melamine-formaldehyde (MF), melamine-urea-formaldehyde (MUF), and polymeric methylene diphenyl diisocyanate (pMDI). Polyvinyl acetate (PVAc) and polyvinyl alcohol (PVOH) polymers, in solution or solids, are also used as adhesives in wood products and many other adhesive applications. The North American resin market for wood-based products is estimated to be about 1.5 million tones (MT). PF resin is one of the most employed adhesives given its good properties. However, there is a great need to reduce the cost of adhesives used in these wood products. Also, there is a need to reduce the consumption of petroleum based products and reduce or eliminate the use of toxic chemicals such as formaldehyde. Formaldehyde was classified by the Environmental Protection Agency (EPA) as a carcinogen chemical. Its use in several applications is being banned in many countries and states. There is room for lignin extracted from renewable sources to be the major ingredient of new types of adhesives for this market segment and for others. The other high volume market (global market is about 200 MT) where meltable lignin compositions can respond well to the need of achieving high bonding strength with humidity and water resistance in corrugated board.

Several lignin based adhesive formulations have been proposed for wood products during the last few years. Lignin has several functional groups that should react with the appropriate chemicals to yield adhesive formulations. The use of lignin-phenol-formaldehyde (LPF) resins has been investigated and is well documented in literature.

U.S. Pat. No. 5,202,403 proposed to mix lignin with PF resin prepared using formaldehyde to phenol (F:P) ratio of less than 1. More formaldehyde was added to increase the ratio F:P to about 3. The resulting adhesive was employed in plywood fabrication. The lignin represented about 5-20% (preferably 12%) by weight of the total resin formulation. A significant amount of formaldehyde is used in the adhesive.

U.S. Pat. No. 8,445,563 proposed a method of making an adhesive for OSB by reacting formaldehyde, methanol, alkaline metal hydroxide or carbonate, urea and degraded lignin. The lignin added represents about 5-20% of the total solids of the mix.

U.S. Pat. No. 9,469,795 used low molecular weight lignin in combination with a fraction of high molecular weight lignin to prepare a PF resin for plywood. The lignin was partially substituting the phenol in the formulation. A significant amount of phenol formaldehyde was still part of the formulation.

Meltable lignin compositions produced with selected chemicals as described herein were found to perform as efficient adhesives for wood products when combined with resol FP or UF resins. They were capable of substituting large proportions in final formulations of these resins while maintaining or even improving the adhesive strength. They also promoted wet strength, especially for UF resins.

### Example I

### Preparation of Meltable Lignin Composition

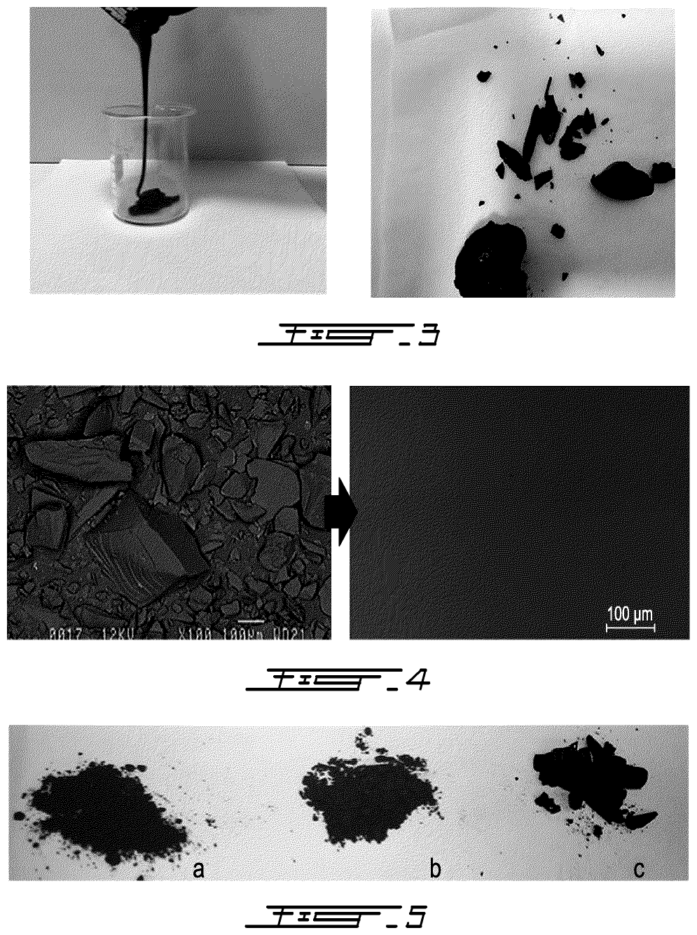

FIG. 3 shows a photo of one example of a meltable lignin composition after mixing the dry H-form lignin with a reactive molecule of the invention. The microscopy images (FIG. 4) show the meltable lignin composition in granular form (left photo) and the corresponding magnification (right photo) that illustrates complete transformation of the original H-form lignin. Upon mixing, the blend flows (FIG. 3; left photo) hardens with time to give a dark solid (FIG. 3; right photo) that melts again upon heating.

Softwood H-form kraft lignin was used with 0 to 10% moisture content and pH=2.3-5.3 (measured at 10% aqueous suspension). A sharp decrease in pH (below 0.5) was observed at room temperature when the dry H-form lignin was slowly added to either propylene carbonate (pH 7.0) or furfural (pH 3.8) under stirring until a viscous composition was formed.

### Example II

### Preparation of Meltable Lignin Composition

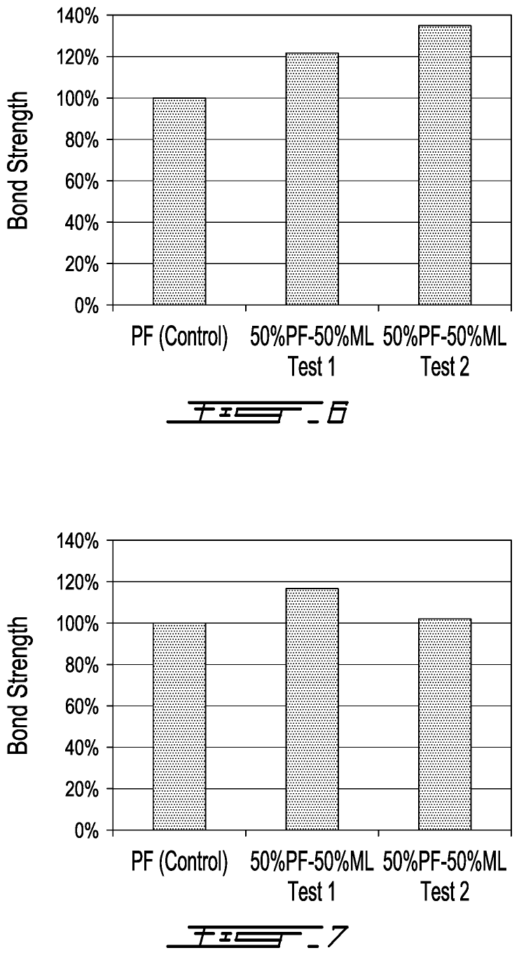

The Gelimat compounder was used to rapidly produce a meltable lignin composition. H-form hardwood kraft lignin with a solid content of 94.2% and pH of 3.78 (measured at 2% aqueous solution) was used. Propylene carbonate (10 wt %) was added to the lignin powder (90 wt %) in a mortar with paddle to pre-mix the two components. Subsequently, the mixture was introduced to the Gelimat thermo kinetic compounder then blending was carried out at 5000 rpm for less than 40 seconds then at 3500 rpm for 90 seconds. The lignin at each stage is shown in FIG. 5.

### Example III

### Preparation of Meltable Lignin Composition

It has been observed that meltable lignin compositions do not form when the lignin is wet or when it has moisture content higher than 10%. Meltable lignin compositions can be formed at room temperature without applying heat when molecules like furfural and furfuryl alcohol are used. When using other single molecules or combination of molecules, heat can be needed in one case, but not in the other. One example is when maleic anhydride is used to make a meltable lignin composition.
Case 1: Maleic anhydride is a solid at room temperature and melts at 52° C. To make a meltable lignin composition with maleic anhydride, the system needs to be heated to at least 52° C.
Case 2: Solid maleic anhydride is dissolved in glycidyl methacrylate (41 wt % maleic anhydride:59 wt % glycidyl methacrylate) at room temperature and then lignin is added so that the final lignin content in the composition is 61 wt %. The meltable lignin composition is formed at 30-35° C., which is lower than the melting point of maleic anhydride.

### Example IV

### Thermal Characterization of Meltable Lignin Compositions

Glass transition temperature (Tg) of lignin is measured by differential scanning calorimetry (DSC). Reported Tg values for softwood kraft lignin=141-162° C. and for hardwood kraft lignin Tg=108-130° C. [Feldman and Banu (1997, J. Appl. Polym. Sci., Vol. 66, 1731-1744), Glasser (2000, In Lignin: Historical, Biological and Materials Perspectives, Ed(s) Glasser W. G., Northey R. A. and Schultz T. P., American Chemical Society, Washington, pp. 216-238), Kadla and Kubo (2004, Composites Part A, Vol. 35, 395-400), Bouajila et al. (2006, J. Appl. Polym. Sci., Vol. 102, 1445-1451), Cui et al. (2013, Bioresources, Vol. 8, 864-886)].

Table 1 shows the differential scanning calorimetry (DSC) data of meltable lignin compositions produced by blending softwood kraft lignin (less than 5% moisture) in the H-form with propylene carbonate (PC) (70 wt % lignin:30 wt % PC) at different temperatures for 5 minutes using a Haake PolyLab QC mixer (bench model) form Thermo Scientific. The scanning profiles were as follows: 1) 10° C./min heating rate from −40° C. to 200° C. (run 1), 2) cool down from 200° C. to −40° C., and 3) heating again from −40° C. to 200° C. (run 2). For the meltable lignin composition prepared at 90° C., the Tg was 44.1° C. (run 1). The glass transition temperature relevant to our application is the one measured during run 1. This is because the sample undergoes some reactions when it is heated up to 200° C. After being cooled down for the second test (run 2), it is no longer considered as an intermediate compound. Table 1 also shows the range of Tg values (43-106° C.) for meltable lignin compositions prepared at other temperatures. These data and observations in Example III clearly show that these compositions demonstrate thermoplastic-like properties. It should be understood by a skilled person in the art that depending on such factors as the molecule or combination of molecules, as described herein, that the lignin is blended with, the lignin to molecule blending ratio as well as the blending temperature and time, compositions will be obtained with different glass transition temperatures and thermoplastic characteristics.

TABLE 1
Glass transition temperature of meltable lignin compositions
(MLC; 70% softwood lignin and 30% propylene carbonate)

| Material and | | |
|---|---|---|
| mixing | Glass | Glass |
| temperature | transition Tg | transition Tg |
| (° C.) | (° C.); Run 1 | (° C.); Run 2 |
| Lignin | N.A. | 172.8 |
| MLC - 70 | 106.2 | 110.7 |
| MLC - 90 | 44.1 | 49.9 |
| MLC - 110 | 52.3 | 85.2 |
| MLC - 130 | 43.6 | 76.4 |
| MLC - 150 | 55.8 | 78.1 |
| MLC - 180 | 69.5 | 92.6 |

### Example V

### Meltable Lignin Compositions in Urea-Formaldehyde Wood Adhesives for Plywood Application

Urea-formaldehyde resin (hereafter UF) was obtained from a local resin supplier in Quebec for wood product applications. The solid content was 60% by weight. The viscosity was 1230 cps at 25° C. using Brookfield viscometer. The pH of the UF resin was 8.2.

A sample of meltable lignin composition was prepared by mixing lignin with propylene carbonate at about 45° C. Dried lignin having moisture content of about less than 5% was added slowly to the propylene carbonate container while mixing gently. Lignin addition was stopped when the meltable lignin contained about 40% lignin.

A portion of the meltable lignin composition was added slowly to a sample of a UF resin (60% solid, 1230 cp) until a mixture of required ratio of UF to meltable lignin composition was obtained. Details are listed below (Table 2).

TABLE 2
Different wood adhesives of UF-meltable lignin

| | | | Meltable | |
|---|---|---|---|---|
| | | | lignin | Final |
| | | Lignin:PC | in resin | solid |
| Code | Resin | ratio | (%) | (%)* |
| Control - UF | UF | — | 0 | 60.0 |
| UFML1 | UF | 60:40 | 30 | 64.5 |
| UFML2 | UF | 60:40 | 50 | 65.9 |
| UFML3 | UF | 50:50 | 30 | 64.5 |
| UFML4 | UF | 50:50 | 50 | 65.9 |
| UFML5 | UF | 40:60 | 30 | 64.5 |
| UFML6 | UF | 40:60 | 50 | 65.9 |

*Meltable lignin is considered as 100% solid

Yellow birch veneers (1.5 mm thick×200 mm wide×230 mm long) were used in this evaluation. The resin was applied to one side of each face layer of the veneer. The plywood making conditions using UF resins are listed below in Table 3.

TABLE 3
Plywood making conditions

| Wood species | Yellow birch |
|---|---|
| Thickness of veneer | 1.5 mm |
| Plywood | 2-ply plywood |
| Resin spread rate | 170-200 g/m² |
| on face ply | |
| Open assembly time | 2-20 minutes |
| Close assembly time | 2-10 minutes |
| Temperature (° C.) | 150 |
| Pressure (KPa) | 1500 |
| Time (min) | 10-15 |
| Release pressure (sec) | 30 |

The homogeneously mixed adhesive was applied on the wood veneers and the 2-ply plywood samples were made following the parameters indicated in Table 4.

For dry adhesive strength test, samples were allowed to equilibrate for at least two weeks at 22° C. and 20% relative humidity prior to testing. For wet adhesive strength test, specimens were soaked in water for 48 hours and then tested while still wet. Strength was measured using an Instron Model 1000 (Norwood, Mass.) with a crosshead speed of 1500 N/min. At each testing condition, 30 specimens for each adhesive were adopted. The results are listed in Table 4.

TABLE 4
Two-ply plywood made with UF-meltable lignin

| | | | Meltable | Final | Dry | Wet |
|---|---|---|---|---|---|---|
| | | Lignin:PC | lignin in | solid | strength | strength |
| Code | Resin | ratio | Resin (%) | (%) | (MPa) | (MPa) |
| Control - UF | UF | — | 0 | 60.0 | 2.87 ± | 0.33 ± |
| | | | | | 0.60 | 0.37 |
| UFML1 | UF | 60:40 | 30 | 64.5 | 3.54 ± | 1.46 ± |
| | | | | | 1.21 | 0.49 |
| UFML2 | UF | 60:40 | 50 | 65.9 | 3.07 ± | 1.40 ± |
| | | | | | 0.78 | 0.64 |
| UFML3 | UF | 50:50 | 30 | 64.5 | 3.31 ± | 1.36 ± |
| | | | | | 0.85 | 0.54 |
| UFML4 | UF | 50:50 | 50 | 65.9 | 2.81 ± | 1.36 ± |
| | | | | | 0.65 | 0.51 |
| UFML5 | UF | 40:60 | 30 | 64.5 | 3.21 ± | 1.61 ± |
| | | | | | 0.97 | 0.55 |
| UFML6 | UF | 40:60 | 50 | 65.9 | 3.47 ± | 1.71 ± |
| | | | | | 0.87 | 0.54 |

As seen, all the formulations of UF resin with meltable lignin gave higher dry adhesive strength than control, with 23% as the highest increase. Similarly, all the UF resin with meltable lignin formulations had 4-5 times higher wet adhesive strength than the control.

### Example VI

### Meltable Lignin Compositions in Phenol-Formaldehyde Wood Adhesives for Plywood Application

PF resins having a viscosity ranging from 500-4000 cp and solids content of about 40% were used as a control in making the plywood strips. At a later stage it was employed with meltable lignin and used as an adhesive for the wood veneers. It is also mixed with meltable lignin for evaluation as an adhesive.

The wood veneer were cut along grain direction into specimens of 70 mm by 25 mm. Prior to dry condition tests, the samples were left for about two weeks at 22° C. and 20% relative humidity.

Dried lignin powder from the commercial lignin plant at a Canadian softwood kraft pulp mill was obtained and used. The lignin was in the H-form (acid washed) and has the desirable humidity level.

A sample of meltable lignin composition was prepared by mixing H-form softwood kraft lignin powder with propylene carbonate at about 45° C. Lignin having moisture content of about less than 5% was added slowly to the propylene carbonate container while mixing gently using a low shear laboratory mixer. Lignin addition was stopped when the meltable lignin contained about 40% lignin. A portion of the meltable lignin was added slowly to a sample of a PF resin (40% solids, 635 cp) until a homogenous mixture of 50% PF and 50% (by weight) meltable lignin was obtained. No precipitation of lignin was observed in the final mixture. The homogeneous mixture was then applied on the wood veneers as previously described. Standard samples were cut and prepared to measure the adhesive strength as described in Table 4. Two sets of specimens were prepared and tested. FIG. 6 shows the results of the adhesive strength after substituting 50% PF resin by meltable lignin composition (compared to control). The mix of PF-meltable lignin composition gave higher tensile strength compared to control, by 20% and 34% in the two tests.

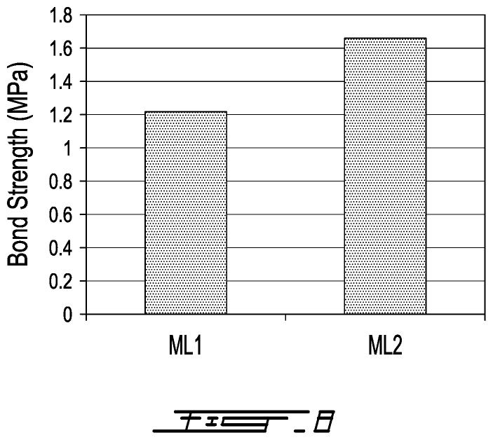

Samples were soaked in water for 48 hours. FIG. 7 shows the results of the tensile strength of the control and the blend PF-meltable lignin composition. Again, the blend gave a higher adhesive strength in both tests compared to the control.

### Example VII

### Meltable Lignin Compositions in Phenol-Formaldehyde Wood Adhesives for Plywood Application

A sample of meltable lignin composition was prepared by heating about 100 g of maleic anhydride until complete melting. Dried lignin having moisture content of about less than 5% was added slowly while stirring gently. Lignin addition was stopped when the meltable lignin composition contained about 50% lignin. A portion of this meltable lignin composition was added slowly to a sample of a PF resin (40% solids, 635 cp) until a mixture of 50% PF and 50% (by weight) meltable lignin composition was obtained. When the adhesive was homogeneously mixed, it was applied on the wood veneers and adhered samples were cut, prepared, and tested as described in Example VI. Compared to a control, the dry adhesive bond strength was about 3.78±0.53 MPa or about 86% of the control made with 100% PF.

### Example VIII

### Meltable Lignin Compositions in Adhesives for Paperboard and Tiles

Two samples of meltable lignin compositions, ML1 and ML2, were prepared as described. ML1 contained 40% propylene carbonate and 60% H-form softwood kraft lignin. ML2 was prepared using 40% furfural and 60% H-form softwood kraft lignin. When each blend of meltable lignin was well mixed, it was applied on the wood veneers and adhered samples were cut, prepared, and tested as described in Example VI. FIG. 8 presents the bond strength of ML1 and ML2 at dry conditions. It is clear that meltable lignin by itself has adhesive properties that vary depending on the compound blended with the H-form of lignin. The bond strength of ML1 or ML2 was not as strong as that of UF or PF resin. However, such meltable lignin blends can find applications as binders and adhesives in paperboard materials, corrugated containers and as adhesives for bonding tiles to walls or other substrates.

### Example IX

### Meltable Lignin Compositions in Polymer Blends

A sample of meltable lignin composition was prepared by mixing lignin with propylene carbonate to about 45° C. Dried lignin having moisture content of about less than 5% was added slowly to the propylene carbonate contained while mixing gently. Lignin addition was stopped when the meltable lignin contains about 50% lignin in one case and 60% in another. A portion of the meltable lignin composition was mixed with granules of PLA (PLA polymer 2000D) in a Haake mixer at 175° C. for about 5 minutes. The blend was composed of 60% PLA and 40% (by weight) meltable lignin composition. Dog bones were made out of the PLA-meltable lignin blend and mechanical properties were evaluated. Table 5 shows the tensile strength and the break elongation of the three polymers. The tensile strength dropped as the meltable lignin was blended with the PLA. However, the elongation at break increased considerably to reach about 800% compared to 12% for neat PLA. The objective of this example was to show that meltable lignin can be tailored with molecules to act as a plasticizer to make stretchable PLA films, but at a reduced tensile strength.

TABLE 5
Tensile strength and elongation of
PLA-meltable lignin polymer blend

| | | 60% PLA | 60% PLA |
|---|---|---|---|
| | | 40% (60% | 40% (50% |
| | 100% PLA | Lignin, 40% PC) | Lignin, 50% PC) |
| Tensile strength | 56.2 | 8.6 | 4.1 |
| (MPa) | | | |
| Elongation to | 11.3 | 104.4 | 829.0 |
| break (%) | | | |

### Example X

### Meltable Lignin Compositions in Polymer Blends

A sample of meltable lignin composition was prepared by mixing lignin with propylene carbonate to about 45° C. Dried lignin having moisture content of about less than 5% was added slowly to the propylene carbonate while mixing gently. Lignin addition was stopped when the meltable lignin contained about 50-60% lignin. Starch powder was mixed with 20% water and added slowly to the meltable lignin mix in the Haake blender under shearing at 110° C. Mixing was continued for 20 min until most water was evaporated and then the temperature was increased to 140° C. with additional 20 min of reaction time afterwards.

The starch/meltable lignin mix was blended with ECOVIO at dosages of 30 and 50%. This mix behaved as a thermoplastic starch.

### Example XI

### Meltable Lignin Compositions in Thermoset Resins

The meltable lignin was found to be very reactive with isocyanate (pMDI). This high reactivity was also an issue when attempting to make PU foams from mixtures of pMDI+polyol+blowing agent+catalyst. But it was possible to produce rigid foams from blend of pMDI and meltable lignin/Polyol+water as catalyst. Adjustments in chemistry could be done for improving application in adhesives and PU foam.

### Example XII

### Meltable Lignin Compositions in Bulk Molding Compounds (BMC)

The meltable lignin compositions were also found to be compatible with many hydrophobic thermoset resins namely unsaturated polyester resins commonly used for making composites (SMC, BMC).

Meltable lignin composition was prepared by first dissolving maleic anhydride in glycidyl methacrylate under stirring at room temperature. Dried lignin with moisture content less than 3% was slowly added to maleic anhydride/glycidyl methacrylate under gentle mixing. To prepare the bulk molding compound (BMC) dough, unsaturated polyester resin and curing agent (tert-butyl peroxybenzoate, TBPB) were manually mixed. This was followed by the addition under mixing of a mold release agent (MOLD WIZ INT-626) and a thickening agent (magnesium oxide). At this point the meltable lignin composition was added. The premix was then introduced to a blade mixer (JAYGO) where glass fibers (Johns Manville chopped glass fiber, fiber length=½ inch) were first added and allowed to mix for 10 min, followed by filler (calcium carbonate) addition and mixing for 10 more minutes. Maturation of the BMC dough was allowed to take place for a period of 3 days. Subsequently, the final BMCs were made by compression molding using a mold and a hot press (CARVER) at about 150-175° C. and 300 psi for 15 minutes to produce BMC boards for testing. Table 6 shows the composition of the BMC doughs prepared, in which the first was a control and the other two were with the addition of meltable lignin composition to replace 25% and 50% of the unsaturated polyester resin, respectively. As seen in Table 6, both experiments of replacing the unsaturated polyester resin with a meltable lignin composition gave composites with comparable tensile and flexural properties as those of the control composite.

TABLE 6
Meltable lignin composition in bulk molding compound

| % meltable lignin composition to | | |
|---|---|---|
| replace unsaturated polyester resin | | |
| 0% (Control) | 25% | 50% |

Chemical composition (per 100 g unsaturated polyester resin)

| Unsaturated polyester resin | | 100 | 75 | 50 |
|---|---|---|---|---|
| Curing agent | | 2 | 2 | 2 |
| Mold release agent | | 3 | 3 | 3 |
| Thickening agent | | 2 | 2 | 2 |
| Filler | | 150 | 150 | 150 |
| Glass Fiber | | 45 | 45 | 45 |
| Meltable | Lignin | 0 | 15.3 | 30.7 |
| lignin | Maleic | 0 | | 7.9 |
| composition | anhydride | | | |
| | Glycidyl | 0 | 5.7 | 11.4 |
| | methacrylate | | | |

Tensile: Standard ASTMD0638

| | | | |
|---|---|---|---|
| Tensile strength, MPa | 42.0 ± 6.6 | 51.8 ± 4.1 | 44.5 ± 4.5 |
| Break elongation, % | 1.0 ± 0.2 | 1.1 ± 0.2 | 0.9 ± 0.2 |
| Modulus, MPa | 6406 ± 252 | 7377 ± 515 | 6532 ± 359 |

Flexural: Standard ASTM0790

| | | | |
|---|---|---|---|
| Maximum flexural stress, MPa | 88.5 ± 9.0 | 99.3 ± 11.0 | 91.7 ± 15.8 |
| Load at maximum flexural stress, N | 126.4 ± 12.9 | 139.2 ± 15.4 | 128.2 ± 22 |
| Modulus of elasticity, MPa | 9867 ± 1013 | 12428 ± 657 | 11365 ± 1223 |

### Example XIII

### Meltable Lignin Compositions in Commercial Glues

The introduction of 50% meltable lignin to commercial polyvinyl acetate glue (white carpenter glue) increased the wet bond strength by 10 times, but reduced the dry bond strength by 49%.

### Example XIV

### Meltable Lignin Compositions in Thermoplastic Polymers

When compounding meltable lignin compositions with several commercial thermoplastic polymers in small lab Haake mixer, it was found that it disperses well in polymer matrices. The polymers tested were PLA, Ecovio, PHB, PCL, PS, PP, PVC, and SAN.

### Example XV

### Meltable Lignin Compositions in Fibrous Materials

The meltable lignin compositions were found to be good compatibilizers for cellulosic or fibrous materials useful for composite and packaging applications.

While the present disclosure has been described in connection with specific embodiments thereof, it will be understood that it is capable of further modifications and this application is intended to cover any variations, uses, or adaptations, including such departures from the present disclosure as come within known or customary practice within the art and as follows in the scope of the appended claims.

What is claimed is:

1. A process of preparing a meltable lignin composition comprising:
a) blending lignin powder with at least one reactive molecule that interferes with lignin's intra- and intermolecular hydrogen bonding and pi-pi interactions producing granular particles upon cooling; and
b) melting the granular particles into meltable lignin with an adjustable glass transition temperature, reactivity, and processability.

2. The process of claim 1, wherein the meltable lignin composition is liquid, viscous or a dense solid material.

3. The process of claim 2, wherein said dense solid material is a pellet, granules or a powder form.

4. The process of any one of claims 1-3, wherein the glass transition temperature is between 30° C. and 120° C.

5. The process of any one of claims 1-4, wherein the lignin powder is blended with the at least one reactive molecule at a temperature between 0° C. and 120° C.

6. The process of any one of claims 1-5, wherein the lignin powder is H-form lignin.

7. The process of claim 6, wherein the lignin is from hardwood, softwood, or another biomass resource.

8. The process of any one of claims 1-7, wherein the lignin powder comprises 0 to 10% moisture.

9. The process of any one of claims 1-8, further comprising the initial step of extracting the lignin powder from kraft black liquor by acidification followed by purification and conversion through acid and water washing.

10. The process of any one of claims 1-9, wherein the lignin powder is a product of the LignoForce™, LignoBoost™ or Westvaco processes.

11. The process of claim 6 or 7, wherein the H-form lignin powder is originally produced from a soda pulping process, a dissolving pulp process from the chip prehydrolysis step prior to pulping, an organosolv process, an enzymatic process or a steam explosion process.

12. The process of any one of claims 1-11, wherein the lignin powder is first passed through a screw feeder before being blended with the at least one reactive molecule.

13. The process of any one of claims 1-12, wherein the lignin powder is blended with the at least one reactive molecule in a jacketed heater with twin arm mixing.

14. The process of claim 13, wherein the mixed lignin powder and the at least one reactive molecule are further passed through a second screw feeder before being mixed in a second jacketed heater with twin arm mixing producing meltable lignin composition in viscous form.

15. The process of any one of claims 1-14, wherein the lignin powder is blended with the at least one reactive molecule in a kneader, an ultrahigh-speed thermokinetic mixer Gelimat from DUSATEC Gelimat™ Technology or an extruder of a single screw or twin screws.

16. The process of any one of claims 1-15, wherein the at least one reactive molecule comprises double or triple bonds; conjugated double or triple bonds; acyl groups attached to oxygen, nitrogen, halogen, or sulphur atoms; halogenated α-carbon of carboxylic acids; glycidyl groups; cyclic structures with hydroxyl or carbonyl groups, or repeat units with oxygen atoms and wherein the reactive molecule is in the liquid or molten solid form.

17. The process of any one of claims 1-16, wherein the at least one reactive molecule is a carbonate ester; an amide and cyclic urea derivative, an aldehyde, a ketone, a conjugated system with carbon-carbon and carbon-nitrogen bonds, a carboxylic acid, a dicarboxylic acid, an acrylic acid, an acrylate, a carboxylic acid anhydride, an acyl halide, a carboxylic acid ester, a furan, an isocyanate, a polyethylene glycol-based polymer, a substituted silane, a sulfone or a sulfoxide.

18. The process of any one of claims 1-17, wherein the at least one reactive molecule is an ethylene carbonate, a propylene carbonate, a glycerine carbonate, a N,N-dimethylformamide, a N,N-dimethylacetamide, urea, a 2-imidazolidone, a 1,3-dimethyl-2-imidazolidinone, a cinnamaldehyde, a vanillin, an acetovanillone, a glyoxal, a cyclohexanone, an acrylonitrile, a styrene, an acetic acid, an acrylic acid, a malic acid, an oxalic acid, a glycidyl methacrylate, a 2-hydroxyethyl methacrylate, a methyl acrylate, a methyl methacrylate, a chloroacetic acid, a trichloroacetic acid, a cyclohexanone, a 1,3-benzenediol, a 1,4-cyclohexanedimethanol, an acetic anhydride, a maleic anhydride, a phthalic anhydride, a succinic anhydride, an acetyl bromide, a ε-caprolactone, a ε-caprolactam, a L-lactide, a vinyl acetate, a polyvinylacetate, poly(butylene adipate-co-terephthalate) (PBAT), triacetin, a furfuryl alcohol, a furfural, a poly(methylene diphenyl diisocyanate), polyethylene glycol, Triton™ X-100, Tween® 20, Tween® 80, a poly(ethylene glycol) diglycidyl ether, a 3-(trimethoxysilyl)propyl methacrylate, a (3-aminopropyl)triethoxysilane, a dimethyl sulfone, or a dimethyl sulfoxide.

19. A meltable lignin composition produced by the process of any one of claims 1-18.

20. The meltable lignin composition of claim 19, further comprising an hydrophobic liquid, a resin, a polymer, a melting chemical liquid, a polar solvent or a non-polar solvent.

21. The meltable lignin composition of claim 19 or 20, further comprising a polyurethane compositions or a thermosetting resin.

22. The meltable lignin composition of any one of claims 19-21, wherein said meltable lignin composition is further bound to an underivatized or derivatized chemical pulp, an underivatized or derivatized mechanical pulp, an underivatized or derivatized organosolv pulp, an underivatized or derivatized non-wood pulp, a plastic, glass, a metal, aluminum, a mineral filler, asphalt, a starch powder, a hemicellulose extract, a wood powder, a wood particle, a wood fiber, dry micro-cellulose material, a nano-cellulose material, or a seed.

23. The meltable lignin composition of any one of claims 19-22, wherein said meltable lignin composition is further compounded with a thermoplastic polymer.

24. The meltable lignin composition of claim 23, wherein said thermoplastic polymer is polyethylene (PE), polypropylene (PP), polyvinyl chloride (PVC), polystyrenes (PS), polypropylene carbonates (PPC), thermoplastic polyurethanes (TPU), thermoplastic elastomers (TPE), acrylonitrile-containing copolymer, asphalt, wax, thermoplastic starch (TPS), polyvinyl alcohol (PVOH), polyethylene oxide (PEO), rubbers, latexes, polyglycolide, polyglycolic acid (PGA), polylactic acid (PLA), polycaprolactone (PCL), polyhydroxyalkanoate (PHA), polyhydroxybutyrate (PHB), polyethylene adipate (PEA), polybutylene succinate (PBS), poly(3-hydroxybutyrate-co-3-hydroxyvalerate) (PHBV), polyethylene terephthalate (PET), polybutylene terephthalate (PBT), cyclic butylene terephthalate (CBT), polybutyrate adipate terephthalate (PBAT), polytrimethylene terephthalate (PTT), or polyethylene naphthalate (PEN).

25. An application composition comprising a meltable lignin composition produced by the process of any one of claims 1-18, wherein said application composition is an adhesive, a thermosetting resin, a thermosetting fiber-reinforced composite, a bulk molding compound (BMC), a sheet molding compound (SMC), a black mulch paper, a black plastic mulch, an asphalt composition, a paperboard material, a corrugated container, a thermoformed-shaped product, a particle board, low density, medium density and high density (LDF, MDF and HDF) board products, a wood-plastic composite, a plastic composition, a thermoplastic starch, an insulating material, a seed coating composition, a wood product, or a concrete composition.
